(19) United States
(12) Patent Application Publication
(10) Pub. No.: US 2021/0202203 A1
(43) Pub. Date: Jul. 1, 2021

(54) THIN AND FLEXIBLE DEVICE THAT ACTS AS A FUSE UNDER EXCESS CURRENT LOAD IN AN MRI RECEIVE COIL

(71) Applicant: Inkspace Imaging, Inc., Pleasanton, CA (US)

(72) Inventors: Joseph Russell Corea, Dublin, CA (US); Gillian Gentry Haemer, Pleasanton, CA (US)

(21) Appl. No.: 17/104,687

(22) Filed: Nov. 25, 2020

Related U.S. Application Data
(60) Provisional application No. 62/940,769, filed on Nov. 26, 2019.

(51) Int. Cl. H01H 85/06; H01H 69/00

(52) U.S. Cl. CPC H01H 85/06; H01H 69/00

(57) ABSTRACT

A flexible and non-magnetic fuse that can be used in a MRI. The fuse is made up of a substrate and a first layer located upon the substrate. The first layer including a first electrical conductor material suspended within a first base material. Upon the first layer is located a second layer. This second is made up of a material that is suspended within a second base material. The second layer has a solid to liquid phase transition temperature lower than a solid to liquid phase transition temperature of a material of the first layer and the second base material intermixes with the first base material at the transition temperature the second layer.

### PRIORITY

This application claims the benefit of priority to U.S. Provisional Patent Application Ser. No. 62/940,769, filed Nov. 26, 2019, which is incorporated by reference herein in its entirety.

### FIELD

The present disclosure relates to a non-magnetic fuse that is lightweight and flexible.

### BACKGROUND

A fuse is an electrical safety device that operates to provide overcurrent protection within an electrical circuit. A typical fuse includes a fuse element such as a metal wire or strip that conducts current when current is below a threshold level and that stops conducting current when the current level exceeds the threshold. A fuse ordinarily operates as a sacrificial device. Once a fuse has operated it becomes an open circuit that must be replaced or rewired. A typical fuse conducts current to a connected electronic circuit that it protects and blocks current from reaching the circuit if the current level exceeds the threshold level. A fuse ordinarily is coupled in series with a protected circuit. For example, some fuse elements melt or physically break when current density exceeds the threshold, thereby interrupting the current flow. Commonly, electrical resistance of a fuse is used to generate heat due to the current flow. The fuse is then constructed so that the heat produced for a normal safe current level below the threshold does not cause the fuse to attain a high-enough temperature to transition to an open circuit, through melting, for example. However, if current exceeds the threshold, a temperature of the fuse rises to a level at which it transitions to a state in which it blocks current flow, through directly melting, or else through melting a soldered joint within the fuse, causing an open circuit between the fuse and a protected circuit element, for example.

A fuse ordinarily is formed of an electrically conductive material, which also, ordinarily is magnetic. Metals such as zinc, copper, silver, iron, and aluminum are common materials used in typical fuses. In some applications, such as protecting MRI coils from overcurrent, fuses formed of non-magnetic materials are required. Non-magnetic fuses are often hard, inflexible, and bulky. Recent advances in MRI receive coils have allowed them to become increasingly thin, lightweight, and flexible. Accordingly, there is a need for a compact non-magnetic fuse that has a flexible construction so as to not become a significant point of strain when coupled to protect a thin, lightweight, flexible circuit.

### SUMMARY

In a first example a fuse comprising: a substrate; a first layer located upon the substrate and including a first electrical conductor material suspended within a first base material; a second layer located upon a portion of the first layer and including a second suspended material, suspended within a second base material; wherein a material of the second layer has a solid to liquid phase transition temperature lower than a solid to liquid phase transition temperature of a material of the first layer; and wherein the second base material intermixes with the first base material when the second layer is in a liquid phase.

A second example which can include the first example, wherein the second suspended material intermixes with the first suspended material when the second layer is in a liquid phase.

A third example which can include the first example wherein the second base material has a solid to liquid phase transition temperature lower than a solid to liquid phase transition temperature of the first base material.

A fourth example which can include the first example or the second example, wherein the second suspended material has a lower melting point temperature than a melting point temperature of the first suspended material.

A fifth example which can include the first example, wherein the second base material etches the first base material when the second layer is in a liquid phase.

A sixth example which can include the fourth example, wherein the etching of the first layer includes a transition under which the materials within the first and second layers combine to form a new heterogeneous or homogeneous material or alloy under high current density conditions.

A seventh example which can include the first example, wherein the first layer includes a first electrical trace portion that has a first width dimension and a second electrical trace portion that has a second width dimension and a third electrical trace portion extending between the first and second traces that has a width dimension independent of the first and second width dimensions.

An eighth example, which can include the seventh example, wherein the third width dimension is narrower than the first width dimension and narrower than the second width dimension.

A ninth example which can include the seventh example or the eight example, wherein the second layer is located upon the third electrical trace portion.

A tenth example which can include the first example or the fourth example, wherein a cohesive force of a liquid phase of the second layer, or a new material or alloy including components of the first and second layers, is larger than the adhesive force between the first layer and the substrate.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1: An illustrative cross-sectional view of an example fuse element.

FIG. 2A: An illustrative cross section view of an example fuse that shows arrangement of materials within first and second layers of the fuse.

FIG. 2B: Another illustrative cross-sectional views of an example fuse showing example transitions of fuse layer materials that may occur when current flow causes the fuse to cross a temperature threshold.

FIG. 2C: Another illustrative cross-sectional views of an example fuse showing example transitions of fuse layer materials that may occur when current flow causes the fuse to cross a temperature threshold.

FIG. 3: An illustrative flow diagram of an example fuse breakage process in response to a current threshold.

FIG. 4: An illustrative top view showing the layout of a first layer on a substrate layer, creating example fuse.

FIG. 5: Illustrates an embodiment.

FIG. 6A: Illustrates by way a color gradient, the relations between the current crowding in the first layer with the placement of the second layer.

FIG. 6B: Illustrates the relations between the current crowding in the first layer with the placement of the second layer is deposited at the location of the highest current density.

FIG. 7: An illustrative cross-section of the relationship in FIG. 6A and FIG. 6B.

FIG. 8A: An example photograph of the second layer shown as small spheres, placed on a first layer shown as a barbell shaped trace, on top of a flexible substrate.

FIG. 8B: An enlarged view taken from 8A, which shows an example photograph of the second layer shown as small spheres, placed on a first layer shown as a barbell shaped trace, on top of a flexible substrate.

FIG. 9A: Shows a photograph of the fuse in the open condition.

FIG. 9B: An enlarged view taken from 9A, shows a photograph of the fuse in the open condition.

FIG. 10A: A top view of a fuse without a second layer before reaching an overcurrent condition.

FIG. 10B: A top view of a fuse without a second layer after an overcurrent condition is reached.

FIG. 11: A graph comparing the fuse current needed to reach overcurrent conditions and blow the fuse device against the resistance of the fuse element as a whole.

FIG. 12: A schematic of a traditional MRI coil. A traditional MRI coil is made of a resonant inductor-capacitor (LC) circuit.

### DETAILED DESCRIPTION

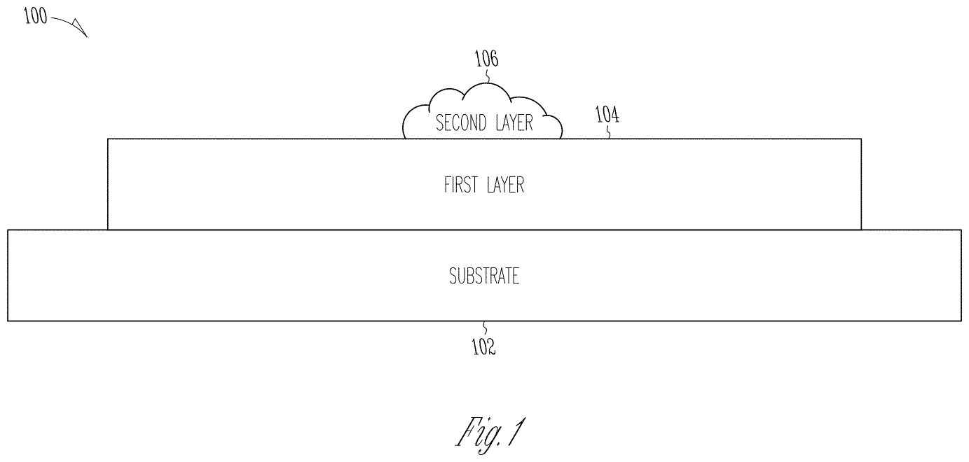

FIG. 1 is an illustrative cross-sectional view of an example fuse element. The fuse element includes a substrate layer 102, a first layer or first conductive layer 104 and a second layer 106. The first layer 104 is deposited on the substrate layer 102 and part of the first layer 104 is sandwiched between the substrate layer 102 and the second layer 106. The substrate layer 102 is a non-conductive, non-magnetic material, and flexible such as plastic. For some applications where the magnetic properties or flexible properties of the material are not required, other materials that are commonly used in the industry can be used. The first conductive layer includes first materials. The second conductive layer includes second materials. An example second layer that includes the second materials has a solid to liquid phase transition temperature lower than a solid to liquid phase transition temperature of the first conductor layer.

Materials for the first layer 104 can include non-magnetic conductive materials deposited by solution processing (e.g., printing) by means of screen printing, gravure printing, inkjet printing, blade coating, stencil patterning, dip coating, or similar. The first layer 104 is comprised of conductive particles 202 imbedded or suspended in an organic material binder 204. The metal flakes or particles can be silver, gold, copper, tin, indium, lead, titanium, tungsten, mixtures/compounds of two or more metals, or similar. The conductive particles can also be made of glass or other non-conductive beads or rods coated in conductive materials.

Materials for the second layer 106 can include metallic particles 208 imbedded in a non-conductive bonder material 206. The metallic particles can include tin, bismuth, lead, silver, copper, gallium, indium, antimony, zinc, or alloys of two or more of these materials. The non-conductive bonder material can include polymer- or flux-based matrices or similar.

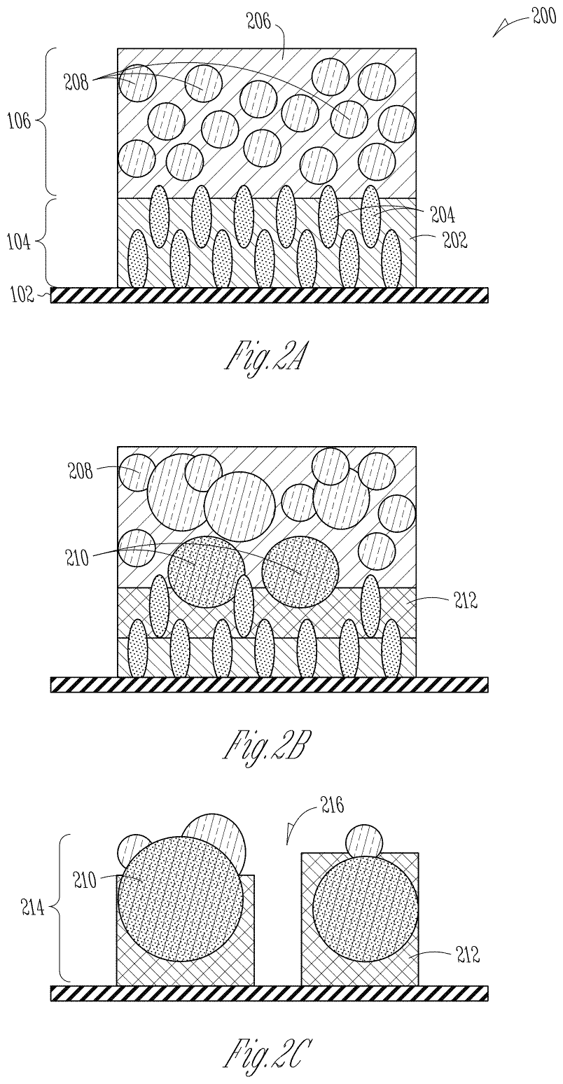

FIG. 2A is an illustrative cross section view of an example fuse that shows arrangement of materials within first and second layers 104, 106 of the fuse. The first layer 104 include a first base material 202 and a first suspended material 204. An example first base material 202 includes an electrically inert substance such as a first polymer. An example first suspended material 204 includes a conductive material such as silver microflakes. The first layer 104 has lower resistivity than the second layer 106, and therefore acts as a conductive current pathway while the fuse current is below a threshold current level. The second layer 106 includes a second base material 206 and a second suspended material 208. An example second base material 206 includes a second polymer that acts a binding agent. The second base material 208 has a property that it cannot bond or react with material that makes up the substrate material 102, and as such it does not stick to the substrate material 102. The second material layer also has a property that it will etch away the trace made up of the first material under elevated current conditions. The second base material 206 can be an inert polymer material, thermally activated chemical flux, or other binding material. An example second suspended material 208 includes small low melting point metallic beads or particles.

FIG. 2B-2C are illustrative cross-sectional views of an example fuse showing example transitions of fuse layer materials that may occur when current flow causes the fuse to cross a temperature threshold. FIG. 2B shows that when over current conditions are reached, the heat that is a product of current crowding causes a material transition, wherein the material of the first layer 104 and the material of the second layer 106 combine to form new materials or alloys. Specifically, in an example fuse, the polymer materials that make up the first base material 202 and the second base material 206 intermix to form a base mixture material 212. Concurrently, in an example fuse, the second suspended material 208 melts. The melted second suspended material consumes the first suspended material 204, by incorporating it into a new suspended mixture material 210 which is a mixture of the first conductive materials 204 and second metallic materials 208. This new mixture may be an alloy of the first and second layers, a suspension of one layer in the other, a new crystalline phase of one or both of the materials, or a combination of two or more results present in the new film. The heat may also activate flux in the second base material 206 causing it to etch the trace formed by the first base layer 104.

FIG. 2C shows that the transformation of the first and second layers to an example combined layer 214 results in the formation of a physical break 216 in the fuse, which blocks current flow. The example combined layer 214 includes the suspended mixture material 210, which is suspended in the base mixture material 212. The combined layer 214 does not adhere to the substrate material 102 as did the unmixed first layer 104 of FIG. 2A. In an example fuse, the polymeric binders in the first layer base material 202 have been disturbed, and the combined layer 214 does not wet the substrate 102 well. This results in a shift in balance between the cohesive forces of the material 214 itself and the adhesive forces between the material 214 and the substrate 102. Once this balance is tipped the material will begin to bead up, causing a physical break 216 in the electrical conduction pathway of the fuse element.

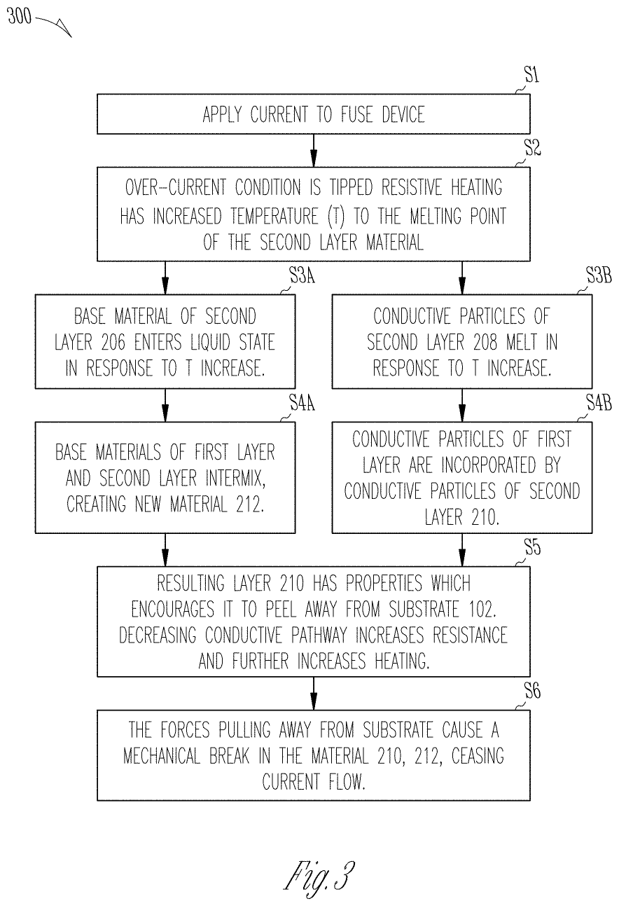

FIG. 3 is an illustrative flow diagram of an example fuse breakage process in response to a current threshold. At 51, the fuse operates at a normal operating condition of the fuse device. If the fuse has current flowing through in a manner such the over current condition is not tripped, the fuse device will work much like a connection between one device and another allowing an electrical connection to be created through the fuse device between any electronics or power source on one side and electronics on the other side that are to be protected from over current conditions. At S2, the increasing current density in the fuse has caused the temperature of the first layer 104 and second layer 106 to increase. At S3a and S3b, the increase in temperature that is caused by the increasing current density causes two concurrent changes to the properties of the materials. First, S3a shows that the second base material 206 is heated to the point where it enters a liquid state. At S4a the first layer base material 202 and the second layer base material 206 begin to intermix with each other to create the base mixture material 212. In an example fuse, the second layer enters into this liquid state first and etches away the trace of the first layer resulting in the intermixing between the two layers. In another example fuse, the two base materials 202, 206 both enter a liquid state and then intermix. The base materials 202, 206 of both the first and second layers 104, 106 contribute to the construction of the fuse, as the first and second suspended materials 204, 208 do not easily adhere to the surface of the substrate 102 alone. Without the presence of a polymeric binder, for example when the binder has been consumed, the suspended conductive material will ball up and often peel or fall off the substrate 102. The second result of exceeding the fusing current, shown in S3b, is a change to the second suspended material 208 in the second layer 106. In some embodiments the second suspended material 208 reaches its melting point at a low temperature. At S4b the low temperature melting point of the second suspended material 208 in the second layer 106 encourages the incorporation of the first suspended material 204 in the first layer, such that the second suspended material 208 effectively consumes the first suspended material 204 in the first layer 104. As the first suspended material 204 in the first layer is incorporated into the suspended mixture material 210, which can be an alloy, there is less conductive material in the first layer 104 through which the current may pass, effectively increasing the current density in the first layer 104. At S5, since the combined layer 214 does not adhere well to the substrate 102, the internal material forces of the combined layer 214 encourage the combined layer 214 to bead up and pull away from, or de-wet from, the substrate 102. As the combined layer 214 de-wets, the conductive trace of the fuse becomes increasingly sparse, additionally restricting current flow through the fuse and increasing current density. Finally, at S6 a physical break of the combined layer 214 of the fuse occurs as the combined layer 214 fully de-wets from the surface of the substrate.

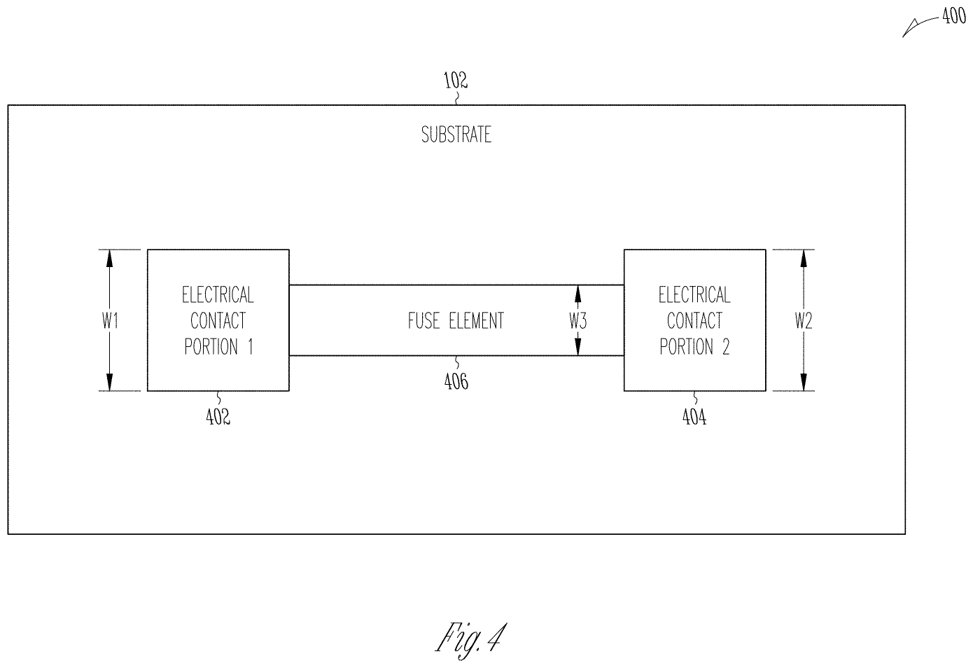

FIG. 4 is an illustrative top view showing the layout of a first layer 104 on a substrate layer 102, creating example fuse 400. To simplify the drawing, the second layer 106 is not shown in FIG. 4. The fuse 400 includes first and second electrical contact conductor portions 402, 404, and a fuse element 406 integrally coupled between them, all of first layer 104. The electrical contacts 402, 404 and the fuse elements 406 make up a path or a trace for the electrical current to flow through the device created by the first layer. As explained below, the fuse element 406 is the electrical trace that ruptures during over current conditions to protect the first and second electrical components coupled to the first and second contacts 402, 404, from damage due to the overcurrent. The first electrical contact conductor portion 402 (referred to herein as ‘first contact’) can be coupled to first electrical circuit components (not shown). The second electrical contact conductor portion 404 (referred to herein as ‘second contact’) can be coupled to second electrical circuit components (not shown). The first and second electrical contacts 402, 404 have first and second widths W1, W2 that are independent of width W3 of the fuse element 406. In an example fuse 400, the first and second widths W1, W2 are determined based on electrical contact resistance, and circuit needs, while the width W3 is determined by the fusing current limits of the device. For this reason, W1 and W2 are often wider than W3. Similarly, the fuse element 406 has a length L and a height H that is determined by the fusing constraints of the device. Decreasing the length L decreases the current density of the trace 406, and therefore increases the fusing current, and vice versa. More specifically, an example fuse 400 include first and second contacts 402, 404 that have widths W1, W2 in a range 50-5000 microns, a fuse element 406 that has a width W3 in a range 20-200 microns, a length in a range 20-5000 microns, and a thickness in the range 3-50 microns. Fuse element 406 is not limited in profile to a straight line between traces 402, 404, and can instead be designed with meanders or bends to increase current crowding to decrease the fuse current of the device.

During normal operation, the fuse 400 is electrically coupled to conduct electrical current between the first and second electrical components. The fuse element 406 that electrically interconnects the first and second contacts 402, 404 has a width chosen to produce a higher current density within the fuse element 406 than within the first and second contacts 402, 404. Thickness of the first layer at the fuse element 406 can also be different from thickness of the first layer at the contacts 402, 404. Both the width and thickness of the fuse element 406 contribute to current crowding, producing greater current density within the fuse element 406 than within the first and second contacts 402, 404, for the same current load.

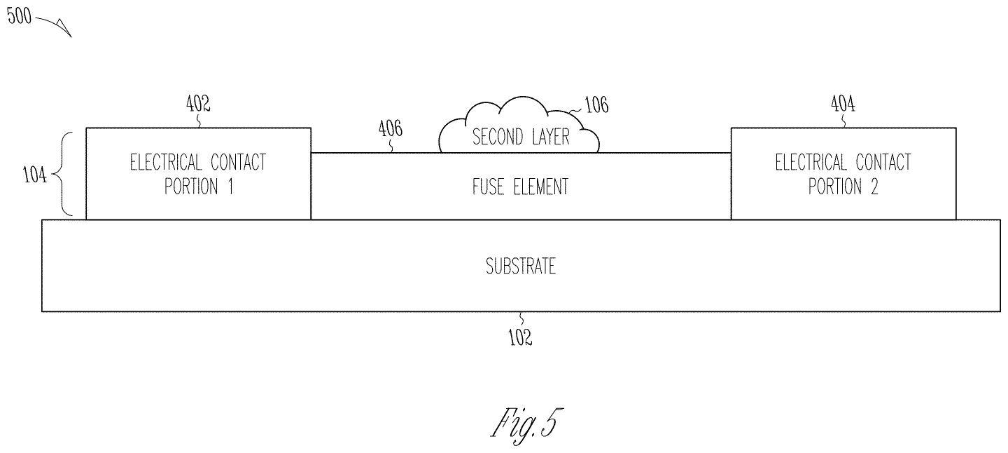

FIG. 5 shows the same embodiment but from a cross-sectional view. The height of first electrical contact portion 402, second electrical contact portion 404, and fuse device 406 as the same, such a condition is not necessary for the function of the device such as width, and length are aspects of the device that form the electrical contact that is make up the first layer 104. Both the width and thickness contribute to the resistive heating properties of the fuse element 406 of the first layer 104. A narrower width W3 of electrical trace portion 406 has a direct relationship to the resistive heating of electrical trace portion 406. Placement of the second layer 106 is determined by the position of highest current density along the trace 406. Careful control of this placement of the second layer 106 helps control the fuse current of the device.

The material for the trace of the first layer 104 is deposited on a flexible substrate 102. The portions of the first layer 106 that make up the electrical contact 402, 404 and the fuse element 406 can be deposited either at the same time or at different times dependent on the method of deposition. Fuse element 406 needs to be deposited before the second layer 106 of the fuse device. A screen-printing method may be used for deposition; however, method of deposit does not affect fuse function. For example, the first layer 104, can be deposited by methods of deposition such as sputtering, chemical vapor deposition, evaporation, chemical bath deposition, plating, or other methods. The first layer 104 also can be deposited and then etched into a form that the fuse should ultimately take. The second layer 106 could similarly be deposited onto the first layer 104. The first layer 104 may be heated to just below the melting point before depositing the second layer 106, causing the metallic particles in the ink to anneal. The annealing process allows the metallic particles suspended in the polymer base layer to move closer together to form tighter and more conductive bonds. This significantly reduces the resistance of the trace. This step may be referred to as “pre-annealing”. The pre-annealing step can be performed electrically, by applying a specific current and using current crowding to heat the trace, or thermally in an oven or on a hot plate, in order to reduce the fuse resistance. After deposition of the trace metal and pre-annealing, a second material is deposited on top of the section of the fuse where the highest current crowding will occur 106.

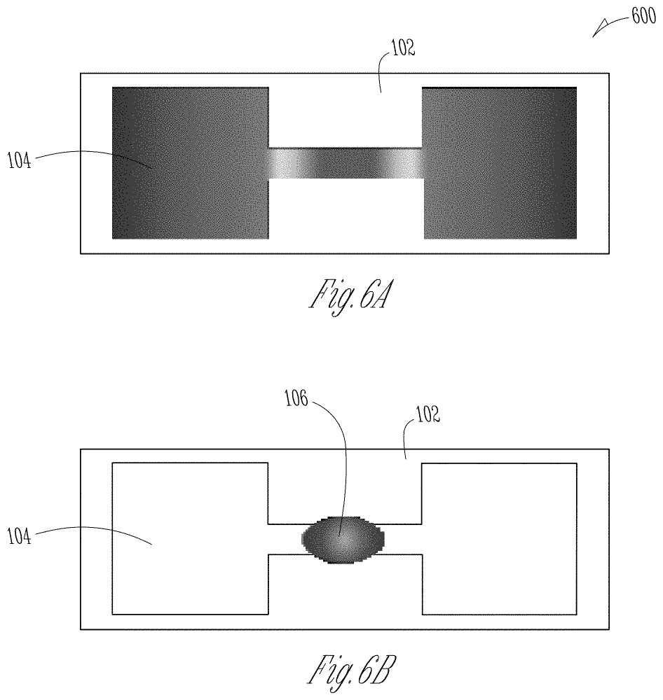

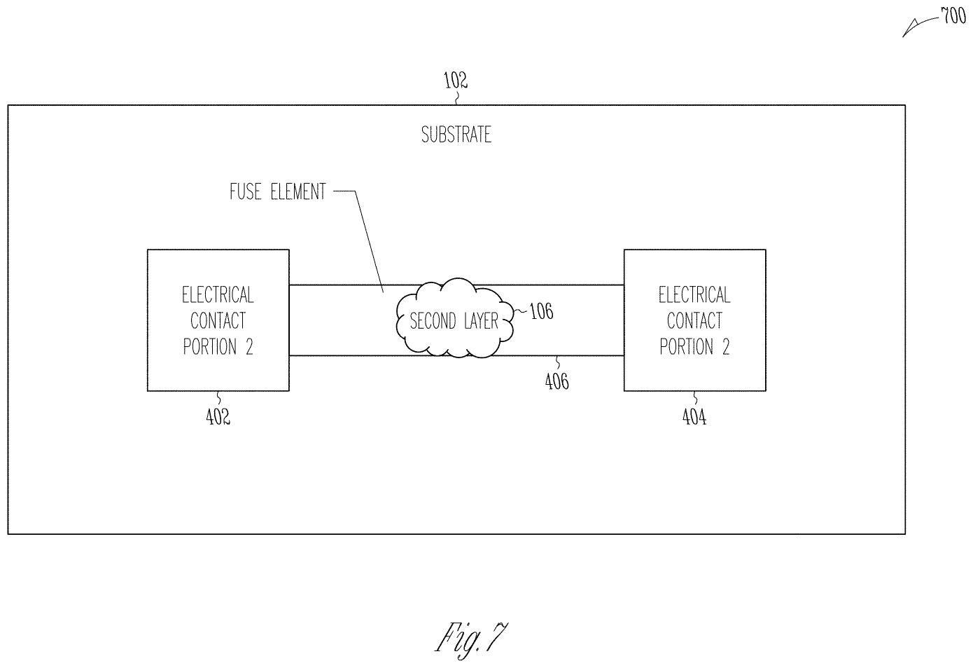

FIGS. 6A and 6B illustrate the relations between the current crowding in the first layer 104 with the placement of the second layer 106. FIG. 7 shows this same relationship in a schematic manner. When current is passed from one side to the other across the electrical trace of the fuse, current crowding will occur in the part of the conductor with the smallest cross-sectional area, in this case at the center of the fuse. FIG. 6A shows this by way showing a color gradient on the schematic. The blue area is where the lowest current density is, and red areas are locations of higher current density. Current crowding will cause heating in the fuse, with the hottest regions located at the positions with the highest current density. The second layer 106 is deposited at the location of the highest current density, as shown in FIG. 6B. The second conductive materials 208 has a lower melting point than the first conductive material 204, the heating due to current crowding will melt the conductive material of the second layer 106 before the melting point of the grey first layer 104 is reached.

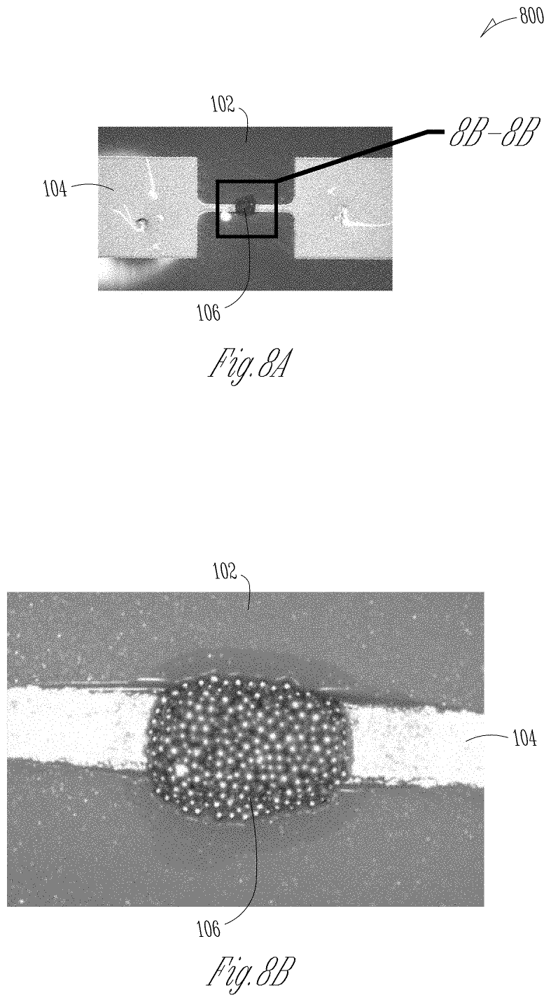

Further illustrating this placement is FIG. 8A and FIG. 8B, in which 8B is an enlarged view taken from 8A along the line 8B-8B, which shows an example photograph of the second layer 106 shown as small spheres, placed on a first layer 104 shown as a barbell shaped sliver trace, on top of a grey flexible substrate 102. The point at which the second layer material 106 is deposited on to the fuse should be the point which has the most current crowding. Generally, this point on the electrical trace that has the smallest cross-sectional area, because that corresponds with the place on the trace that has the most current crowding. This pattern is designed such that there is a section that has a very small total area (thickness and width). Eventually, if sufficient current is continuously passed through the fuse the first conductive material layer will reach the melting point. When the melting point is reached the conductive material will melt and eventually break, or “open” the fuse.

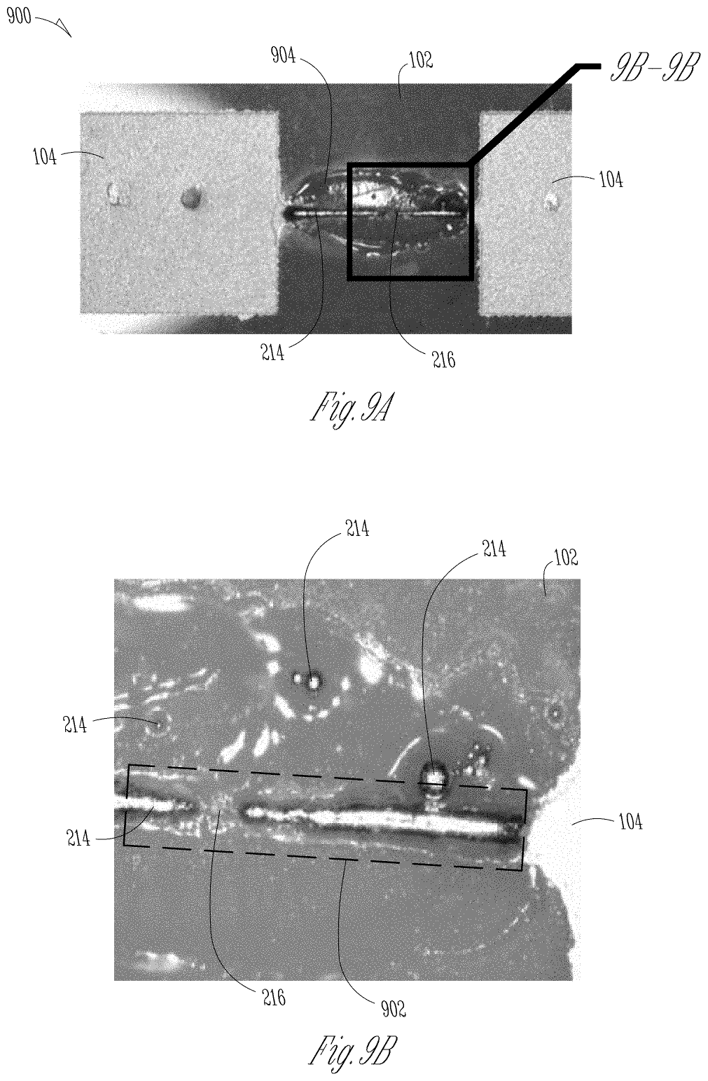

The FIG. 9A and FIG. 9B, in which 9B is an enlarged view taken from 9A along the line 9B-9B, shows a photograph of the fuse in the open condition. The insert clearly shows the mechanical breakage that occurs as a result of the above described physical and material properties under overcurrent conditions. FIG. 9B also shows that when the second conductive layer 106 melts due to temperature increase caused by current crowding, the second layer 106 etches away the first conductive layer 104, forming a new material. The intermixing of the first layer 104 and the second layer 106 creates a new suspended conductive material 210 and a residual material 212, together referred to as material 214. This new material layer 214 pulls away from the substrate 102, effectively opening the fuse. This can be seen in FIG. 9B, where the residual outline 902 of the original trace 406 can be seen to be wider than the resultant material 214. Additionally, the combination of the materials does not adhere well to the substrate 102 and promotes delamination as the base layer of the trace is consumed, which helps open the circuit. The original polymer binder of layer 104 is no longer present and resulting combined material or alloy 214 does not stick to surface 102 well. The new material does not adhere to the surface, and instead the new alloy 214 shows signs of higher internal cohesive forces, as seen in the formation of the balling up of material on the substrate surface after the fuse is blown 214. This behavior suggests that when the fuse current is exceeded and the material goes from solid to liquid state, the cohesive force within the second material 106 or the combined first and second materials 214 is larger than an adhesive force between these materials and the substrate 102. This causes the device to physically break, and puts the circuit in an open state, preventing overcurrent conditions from occurring in the protected circuitry. If the polymer binders in the second base material 206 include a thermally activated chemical flux, activated flux will aid in the etching of the fuse trace 406 below the second layer, and the speed of the process can be increased. Residual flux (904) from the second layer 106 can be seen on substrate 102 around the opened fuse trace in the example fuse 900.

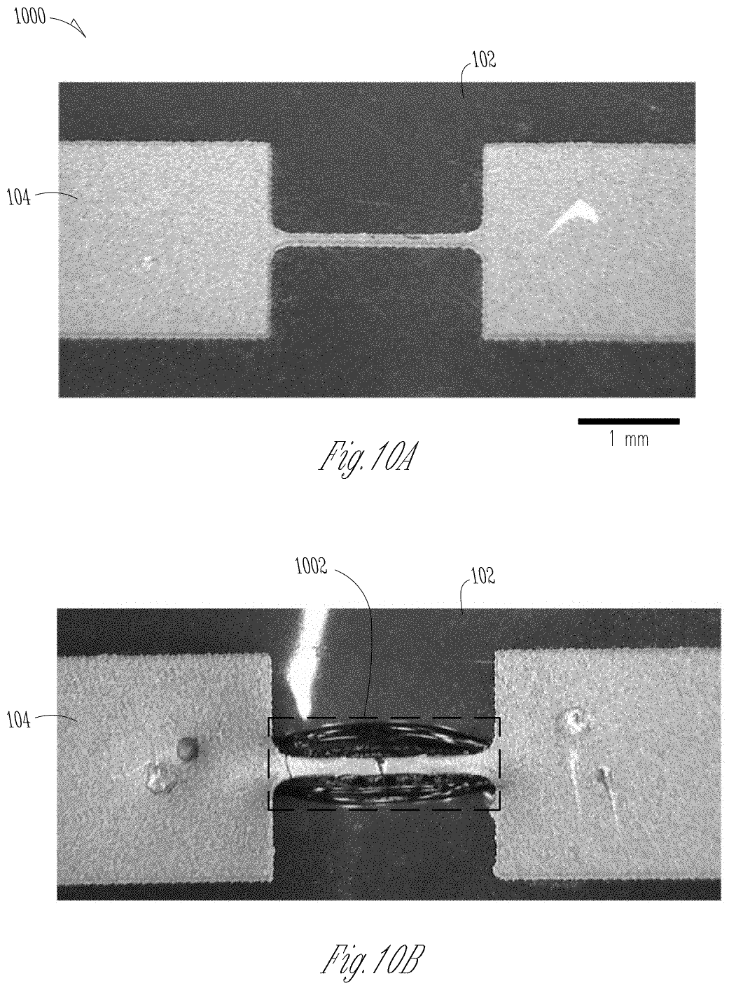

FIGS. 10A and 10B illustrate a fuse device that does not have a second layer 106. The second layer 106 effectively lowers the fusing current of the base material without compromising the conductivity of the trace and therefore the fuse resistance. If no second layer 106 is present, as shown in FIGS. 10A and 10B, current crowding in the trace layer can be increased up until the melting point of the trace material is reached. At that point the material breaks down and the fuse is blown. FIGS. 10A and 10B show the before and after of this fusing process for a fuse without a second layer 106. FIG. 10A shows a top view of the device with the gray representing the first layer 104 and the black representing the non-conductive flexible plastic substrate 102. FIG. 10B shows that when an overcurrent condition is reached, the area of the substrate 102 that is directly around the fuse element or was touching the fuse element 406, which corresponds to the thinnest section of the first layer 104, has completely melted away (1002). This indicates a much higher temperature was reached due to much higher current crowding before the fuse was blown. In practice this corresponds to a much higher fuse current for the same fuse trace 406, and therefore the same fuse resistivity, or a much higher fuse resistivity, and a variation of the fuse trace 406, to ensure the same fuse current for a given device. In order to achieve the same fuse current as a fuse with second layer 106, such as fuse 800, the cross-sectional area of the trace 406 would need to be reduced in order to increase current crowding. This reduction of the trace area would lead to a reciprocal increased resistance of the trace under normal operating conditions.

Since all layers of the fuse device described by the various embodiments and examples are made up of flexible materials such as a flexible substrate 102 or particles imbedded in a polymer matrix 202, 206, 212, the entire resulting device is flexible. All constituent layers are also non-magnetic, making the device as a whole non-magnetic and therefore MR-compliant. The device itself is also low-profile, as the completed device is less than 100 microns thick, and mechanically sturdy to impact or drop testing. The device is also RoHS compliant and complaint with other medical device requirements, such as IEC60601. All of these benefits make the fuse device described an optimal component for biomedical applications.

### Examples

Fuse performance for MRI receive coils has traditionally been measured by three factors. First, the fuse itself (including all packaging) must be nonmagnetic. Second, the fusing current rating must be low enough that the receive coil does not produce a significant specific absorption rate (SAR) in the subject before the fuse is blown; typical fusing current ratings range between 200 mA and 1 A depending on the frequency of interest and size of the receive coil. Finally, the resistance of the fuse must be low enough to not impact receive coil performance. This means that the fuse resistance must not be significantly higher that the resistance of the rest of the coil components (up to 0.9 ohms).

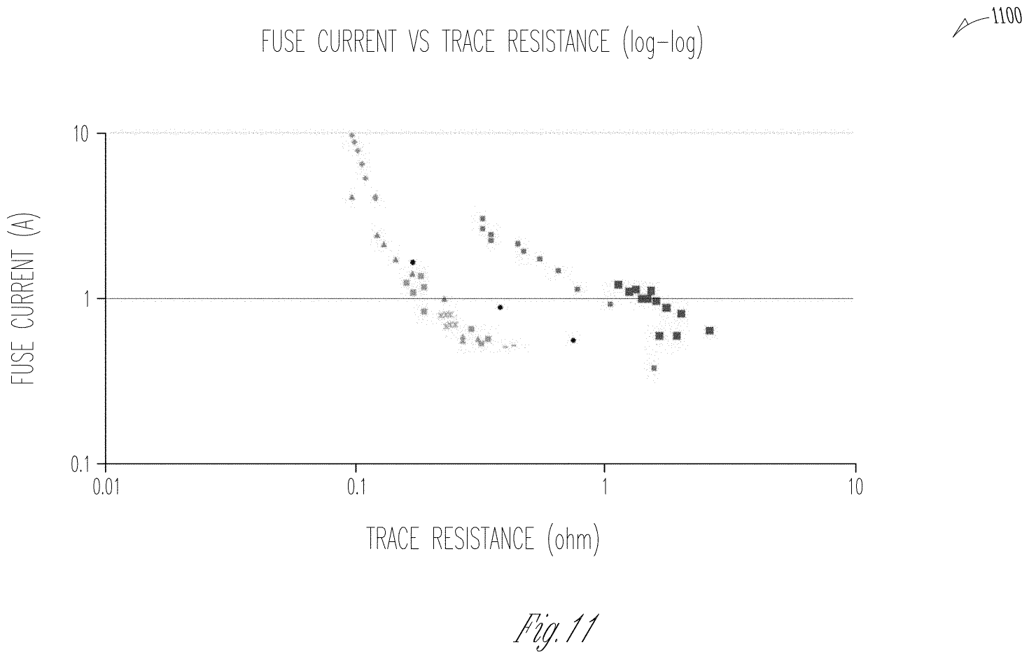

The concepts and constructions described above for the fuse device were used to produce and test various embodiments of fuse devices. Various fuses were tested, and by varying the cross sectional area of trace 406 and the material composition of the secondary layer, a variety of fuses were generated. FIG. 11 presents a graph comparing the fuse current needed to reach overcurrent conditions and blow the fuse device against the resistance of the fuse element as a whole. Various commercial fuses were compared against the tested fuse devices. Fuse current was measured by a direct application of continuous DC current, and was defined as the current limit of the fuse before an almost immediate fuse blow (less than 5 seconds). The goal was to produce devices that do not contribute a large resistance for a given fusing current. For some uses of the fuse device, data closer to the lower left quadrant of the graph, nearer to the origin, are more desirable.

FIG. 11 graphs the fusing current vs trace resistance for these various fuse types. Copper traces (green) have very high fuse currents. Commercially available fuses (black) and silver microflake fuses (red) have much higher resistance values for a given fusing current than the embodiments and example of the flexible fuse that where tested (orange). The current rating of fuses is defined based on a standard characterization of a “fast-blow fuse”. A “fast-blow fuse” is defined as a fuse that opens within 5 seconds when twice the fuse current rating is applied and does not blow after 4 hours of consistent application of the fuse current. For our experimental measurements, the fuse devices as described above in various embodiments were characterized by the current required to open the fuse in less than 5 seconds. To compare these values to those on a fast-blow fuse datasheet it is reasonable to divide the fusing current of FIG. 11 by two and consider this close to the fast-blow fuse rating of these devices.

### Flexible Fuse in an MRI System:

During an MRI scan, tissue in the subject is excited with radiofrequency (RF) energy to create a nuclear magnetic resonance signal. This excitation signal is produced using a resonant antenna, called a transmit coil. The excited signal in the subject then relaxes back to a steady state. During relaxation this signal induces a current in nearby receive coil arrays by faraday induction; referred to as reception. This induced signal is relayed back to the MRI scanner, and used to create an image. Receive coil arrays are composed of one or more loops of wire that are connected to the scanner by lengths of coaxial cable and are designed to be sensitive to the MRI resonant frequency (often referred to as the coil being “tuned” or “resonant”). Receive coils are generally placed as close to the patient as possible, to maximize their sensitivity to the signal coming from patient during reception, and therefore are positioned within the excitation field produced by the transmit coil. Receive coils in practice are almost always located within the actual volume of the transmit coil. Because receive coils are tuned to the MRI resonant frequency, and this is the same frequency of the signal driven by the transmit coil, they are inherently sensitive to the transmit field. If left tuned during transmission, significant current can be driven in the receive coils. This poses both an imaging issue and a safety risk. Energy deposited during transmission is far greater that energy released from the body during reception. Therefore, the amount of current driven in a receive coil coupled to the transmit field will be substantially larger than the current the receive coil circuitry was designed to hold. The first potential risk from this high current therefore, is that it can do significant damage to the receive hardware chain. Current driven in the receive coil during transmission will additionally generate a respective magnetic field, localized around the receive coil. This field will distort the transmitted field from what is expected by the MRI system, causing significant imaging artifacts, and will deposit energy locally, measured as specific absorption rate (SAR). The imaging artifacts can obscure important diagnostic results. The local energy (SAR) deposition can cause local heating and potentially burn the subject. Therefore, the current in these devices must be limited.

In practice, to prevent current excitation in receive coils during transmission, protection mechanisms are used to detune receive coils during transmit. Active detuning is a mechanism that uses a DC-driven PIN diode to generate a high-impedance at the resonant frequency in the coil. This effectively detunes the receive coil by blocking current in the loop. This technique is commonly referred to as “detuning” “Q-spoiling” or “decoupling from the transmit field.” Active detuning is often accompanied by passive detuning. Passive detuning generally uses the same circuits and mechanisms as active detuning, and places a cross diode pair in parallel with the DC-driven PIN diode. In the event that the PIN diode bias is not active (ex: disconnection from the DC bias source, broken PIN diode) the signal driven in the receive coil by the transmit coil will power on the cross diode pair, activating the detuning circuitry and protecting the subject during transmit.

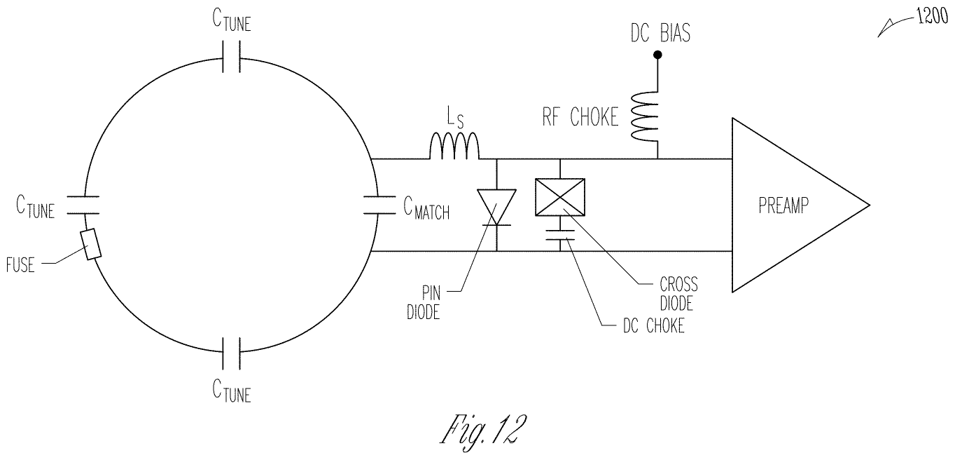

FIG. 12 is a schematic of a traditional MRI coil. A traditional MRI coil is made of a resonant inductor-capacitor (LC) circuit. This is typically a loop of wire or other inductive material with capacitive elements distributed throughout. The capacitive elements in the coil shown above have two different purposes. Capacitors C_{Tune} serve to “tune” the coil's resonant frequency, which is inversely proportional to total capacitance and inductance of the circuit. Capacitor C_{Match} matches the coil so that it may be most efficiently connected to the preamp. These capacitors can be the same values, or different values; their value does not change the function of the coil, only it's efficiency at a given resonant frequency. The output from either side of C_{Match} becomes the differential signal of the coil. Let's call the top output, feeding into L_{S} “signal” and the bottom output “ground.” During receive mode, when there is no DC bias, the signal and ground outputs will feed into the preamplifier, and this differential signal will be transmitted to the MRI for processing. The industry standard for MRI requires a third layer of protection, such as a fuse, placed within the resonant circuit.

Active detuning is when the coil is actively detuned using a DC current, fed into the system through an RF choke. This DC current creates a short across a PIN diode, forming a second resonant circuit (PIN Diode->Ground->C_{Match}->Signal->L_{S}). An inductor L_{S} is used to tune this resonant circuit to provide a high impedance across C_{Match} during active detuning. This high impedance effectively turns capacitor C_{Match} into an open at the resonant frequency when the diode is biased. If C_{Match} is an open, the coil is not resonant, and therefore the coil is safe during transmit.

Passive detuning uses this same tuned resonant circuit without the PIN diode. If the RF choke inductor or PIN diode breaks, the DC bias driven active detuning circuit would not be active during transmit. In the absence of this circuitry, an increasing voltage differential between signal and ground will immediately turn on the cross diode, effectively creating a short between signal and ground. This will behave electrically just like an actively biased PIN diode, again effectively turning capacitor C_{Match} into an open at the resonant frequency during transmit. A DC choke capacitor is placed between the cross diode and Ground, so that it is not biased during active detuning.

If there is a fault in the system between the PIN and cross diodes and the coil, for example inductor L_{S} is broken, both active detuning and passive detuning will be disconnected. In this case, a fuse on the coil provides a final safety mechanism. In some embodiments, the first contact 402 of the fuse device can be coupled to first electrical circuit components, such as the output of one of the C_{Tune} capacitors. The second contact 404 fuse device can in some embodiments be coupled to second electrical circuit components, such as the input of another of the C_{Tune} capacitor. Generally, the fuse component is placed at a location of high current density in the resonant circuit of the coil itself and must run in series with the current pathway of the coil. Typically, the highest current density points of an LC circuit are close to the capacitive elements. In principle a fuse can be considered a lumped element, which serves as a very small resistor during typical use, but which will open, or break, if the current through the fuse exceeds the current specified for the component, called the fusing current. The fuse will limit the current in the coil to a safe level, and if the current exceeds the fusing current (for example if the coil is left resonant during transmit), the fuse will become an open, safely rendering the coil non-resonant.

Using the device, we describe here, we can create a nonmagnetic, inherently flexible fuse. This fuse does not show significant variation in performance while being flexed or bent, and both the resistance and fuse current can be adjusted for the application during production. The above device was described for use in MRI but other applications such as wearable devices where high conductivity and low fuse current are desirable. In such cases the use of non-magnetic materials would not be necessary like they are in MRI applications.

### Example

In a first example a fuse comprising: a substrate; a first layer located upon the substrate and including a first electrical conductor material suspended within a first base material; a second layer located upon a portion of the first layer and including a second suspended material, suspended within a second base material; wherein a material of the second layer has a solid to liquid phase transition temperature lower than a solid to liquid phase transition temperature of a material of the first layer; and wherein the second base material intermixes with the first base material when the second layer is in a liquid phase.

A second example which can include the first example, wherein the second suspended material intermixes with the first suspended material in response to the second layer being in a liquid phase.

A third example which can include the first example, wherein the second base material has a solid to liquid phase transition temperature lower than a solid to liquid phase transition temperature of the first base material.

A fourth example which can include the first example, wherein the second suspended material has a lower melting point temperature than a melting point temperature of the first suspended material.

A fifth example which can include the second example wherein the second suspended material has a lower melting point temperature than a melting point temperature of the first suspended material.

A sixth example which can include the first example wherein the second base material consumes the first base material in response to the second layer being in a liquid phase.

A seventh example which can include the first example, wherein the materials within the first and second layers combine to form an alloy including components of the first and second layers in response to an increase in current density.

An eight example which can include the seventh example or the first example wherein the current density current range is between 200 mA to 1A.

A ninth example which can include the seventh example, wherein the resistance of the fuse is up to 0.9 ohms.

A tenth example which can include the 1 example, wherein the first layer includes a first electrical trace portion that has a first width dimension and a second electrical trace portion that has a second width dimension and a third electrical trace portion extending between the first and second traces that has a third width dimension.

An eleventh example which can include the tenth example, wherein the first width dimension of the first electrical trace portion and second width dimension of the second electrical trace portion have a minimum width of 50 microns and a maximum width of 5000 microns.

A twelfth example which can include the eleventh example, wherein the first width dimension and the second width dimension different widths.

A thirteenth example which can include the tenth example, wherein the third width dimension is narrower than the first width dimension and the second width dimension.

A fourteenth example which can include the twelfth example, where the third electrical trace portion has a minimum width of 20 microns and a maximum width of 200 microns.

A fifteenth example which can include the twelfth example, where the third electrical trace portion has a minimum thickness of 3 microns and a maximum thickness of 50 microns.

A sixteenth example which can include the fifteenth example, where the thickness of the first electrical trace portion and second electrical trace portion is greater than the thickness of the third electrical trace portion.

A seventeenth example which can include the tenth example, where the third electrical trace has a minimum length of 20 microns and maximum length of 5000 microns.

An eighteenth example which can include the first example, wherein the second layer is located upon the third electrical trace portion.

A nineteenth example which can include the first example, wherein a cohesive force of a liquid phase of the second layer is larger than the adhesive force between the first layer and the substrate.

A twentieth example which can include the fourth, wherein a cohesive force of a liquid phase of the second layers larger than the adhesive force between the first layer and the substrate.

A twenty-first example which can include the first example, wherein a cohesive force of a liquid phase of the alloy including components of the first and second layers is larger than the adhesive force between the first layer and the substrate.

A twenty-second example which can include the fourth example, wherein a cohesive force of a liquid phase of the alloy including components of the first and second layers is larger than the adhesive force between the first layer and the substrate.

A twenty-third example where the method to produce a fuse comprising: placing a first layer located upon a substrate and including a first electrical conductor material suspended within a first base material; placing a second layer located upon a portion of the first layer and including a second suspended material, suspended within a second base material; wherein a material of the second layer has a solid to liquid phase transition temperature lower than a solid to liquid phase transition temperature of a material of the first layer; and wherein the second base material intermixes with the first base material the second layer.

A twenty-fourth example which can include the twenty-third example, wherein the second base material consumes the first base material of the first layer in response to the temperature being raised such that the second material is in a liquid phase.

A twenty-fifth example which can include the twenty-third example, wherein placing of the first or second layer is done by sputtering, chemical vapor deposition, evaporation, chemical bath deposition, plating, or screen printing.

A twenty-sixth example which can include the twenty-third example, wherein the first layer includes a first electrical trace portion that has a first width dimension and a second electrical trace portion that has a second width dimension and a third electrical trace portion extending between the first and second traces that has a width dimension independent of the first and second width dimensions.

A twenty-seventh example which can include the twenty-sixth example, wherein the first electrical trace portion coupled to a first electrical contact.

A twenty-eight example which can include the twenty-sixth example, wherein the second electrical trace portion is coupled to a second electrical contact.

A twenty-ninth example which can include the twenty-sixth example, wherein the third the electrical trace portions connects the first electrical contract and the second electrical contact.

A thirtieth example which can include the twenty-sixth example, wherein the third width dimension is narrower than the first width dimension and narrower than the second width dimension and the second layer is located upon the third electrical trace portion.

A thirty-first example which can include the thirtieth example, wherein the third electrical trace portion has at least one bend along the length of the trace.

A thirty-second example which can include the twenty-third example, wherein the first layer is annealed to increase homogeneity of the first layer by heating the first layer before depositing the second layer.

A thirty-third example which can include the twenty-third example, wherein the second suspended material intermixes with the first suspended material in response to the second layer being in a liquid phase and the second suspended material having a lower melting point temperature than a melting point temperature of the first suspended material.

A thirty-fourth example which can include the twenty-third example, wherein the first layer or second layer contains an alloy components that causes a cohesive force of a liquid phase of the second layer intermixing with the first layer to be greater than an adhesive force holding the first layer on the substrate the substrate causing the first layer to pull away from the substrate.

A thirty-fifth example which can include the twenty-third example, wherein all materials for the first layer and the second layer are non-magnetic.

A thirty sixth example which can include the thirty-fifth example, wherein the first layer pulls away from the substrate in less than 5 seconds in response to the second layer intermixing with the first layer.

1. A fuse comprising:
a substrate;
a first layer located upon the substrate and including a first electrical conductor material suspended within a first base material;
a second layer located upon a portion of the first layer and including a second suspended material, suspended within a second base material;
wherein a material of the second layer has a solid to liquid phase transition temperature lower than a solid to liquid phase transition temperature of a material of the first layer; and
wherein the second base material intermixes with the first base material at the transition temperature the second layer.

2. The fuse of claim 1, wherein the second suspended material intermixes with the first suspended material in response to the second layer being in a liquid phase.

3. The fuse of claim 1, wherein the second suspended material has a lower melting point temperature than a melting point temperature of the first suspended material.

4. The fuse of claim 1, wherein the materials within the first and second layers combine to form an alloy including components of the first and second layers in response to an increase in current density.

5. The fuse of claim 4, wherein the current density current range is between 200 mA to 1A.

6. The fuse of claim 4, wherein the resistance of the fuse is up to 0.9 ohms.

7. The fuse of claim 1, wherein the first layer includes a first electrical trace portion that has a first width dimension and a second electrical trace portion that has a second width dimension and a third electrical trace portion extending between the first and second traces that has a third width dimension.

8. The fuse of claim 7, wherein the first width dimension of the first electrical trace portion and second width dimension of the second electrical trace portion have a minimum width of 50 microns and a maximum width of 5000 microns.

9. The fuse of claim 7, wherein the third width dimension is narrower than the first width dimension and the second width dimension.

10. The fuse of claim 1, wherein a cohesive force of a liquid phase of the alloy including components of the first and second layers is larger than the adhesive force between the first layer and the substrate.

11. A method to produce a fuse comprising:
placing a first layer located upon a substrate and including a first electrical conductor material suspended within a first base material;
placing a second layer located upon a portion of the first layer and including a second suspended material, suspended within a second base material;
wherein a material of the second layer has a solid to liquid phase transition temperature lower than a solid to liquid phase transition temperature of a material of the first layer; and
wherein the second base material intermixes with the first base material the second layer.

12. The method of claim 11, wherein placing of the first or second layer is done by sputtering, chemical vapor deposition, evaporation, chemical bath deposition, plating, or screen printing.

13. The method of claim 11, wherein the first layer includes a first electrical trace portion that has a first width dimension and a second electrical trace portion that has a second width dimension and a third electrical trace portion extending between the first and second traces that has a width dimension independent of the first and second width dimensions.

14. The method of claim 13, wherein the first electrical trace portion coupled to a first electrical contact and the second electrical trace portion is coupled to a second electrical contact.

15. The method of claim 13, wherein the third the electrical trace portions connects the first electrical contract and the second electrical contact.

16. The method of claim 13, wherein the third width dimension is narrower than the first width dimension and narrower than the second width dimension and the second layer is located upon the third electrical trace portion.

17. The method of claim 16, wherein the third electrical trace portion has at least one bend along the length of the trace.

18. The method of claim 11, wherein the first layer is annealed to increase homogeneity of the first layer by heating the first layer before depositing the second layer.

19. The method of claim 11, wherein the first layer or second layer contains an alloy components that causes a cohesive force of a liquid phase of the second layer intermixing with the first layer to be greater than an adhesive force holding the first layer on the substrate the substrate causing the first layer to pull away from the substrate.

20. The method of claim 11, wherein all materials for the first layer and the second layer are non-magnetic.
